(19) United States
(12) Patent Application Publication
(10) Pub. No.: US 2022/0058762 A1
(43) Pub. Date: Feb. 24, 2022

(54) SYSTEM AND METHOD FOR TRACKING BAGGAGE ON CRUISE LINERS

(71) Applicant: SITA Information Networking Computing UK Limited, Hayes, Middlesex (GB)

(72) Inventors: Stephen David GODDARD, Little Hampton (GB); Adrien SANGLIER, Geneva (CH); Maurice Royston POPE, West Midlands (GB)

(21) Appl. No.: 17/415,419

(22) PCT Filed: Dec. 18, 2019
(86) PCT No.: PCT/GB2019/053608

§ 371 Date: Jun. 17, 2021

(30) Foreign Application Priority Data
Dec. 21, 2018 (EP) 18215355.1

(51) Int. Cl. G06Q 50/30; G06Q 10/08; G06K 7/14; H04W 4/12

(52) U.S. Cl. CPC G06Q 50/30; G06Q 10/0833; G06Q 10/02; H04W 4/12; G06K 7/1404

(57) ABSTRACT

A system and method for tracking baggage on cruise liners are provided. A baggage tag is created which includes a unique baggage identifier and a unique passenger identifier that has been allocated by a reservation system. The identifiers are associated and stored in a baggage message. The baggage tag is affixed to an item of baggage and as the passenger checks in the item the tag is scanned and the bag validated and the status of the item in the baggage message is updated. When the passenger boards the ship, they scan a touch point with a mobile communications device which indicates that the item of baggage can now be delivered to their cabin. Shortly before arrival at port, the bags are loaded into a baggage container for unloading at the port and each bag tag is scan and associated with a scanned container identifier. The container is notified to the passenger through a message sent to their mobile communications device. When the container is unloaded the bag tag and the container are both scanned to ensure that the item of baggage has been loaded into the correct container and an error is flagged if the container associated with the bag tag does not match the scanned container.

### FIELD OF INVENTION

This invention relates to systems and methods of tracking baggage on cruise liners.

### BACKGROUND TO THE INVENTION

The handling of baggage on cruise liners is at present very simplistic in comparison to airport solutions. The handling of baggage by airlines and airports is controlled by standards such as IATA 753 which requires baggage tracking from the moment a passenger releases a bag to an agent if that agent is not subsequently the airline.

Typically, when embarking on a cruise ship, passengers hand their baggage to an agent upon arrival to a terminal, with hand filled bag tags attached to the bags which identify the ship, the passenger and the passenger's cabin. These bags are transported to the ship manually and delivered to the cabins. Baggage which is not required on the cruise is placed in a hold. At the end of the journey bags are placed in specific zones in the arrival port from which passengers collect them. This is a highly inefficient process and incompatible with onward flights as it contravenes the IATA 753 requirements mentioned above.

There is therefore a need for an improved method and system for handling baggage on cruise liners that addresses these problems.

According to the invention, there is provided a method of tracking baggage on a cruise ship, comprising the steps of: for an item of baggage, generating a unique baggage identifier and associating the unique baggage identifier with a unique passenger identifier to form a unique identifier, the passenger identifier being retrieved from a reservation system; generating and storing a baggage message including the associated unique identifier; generating a baggage tag including the unique identifier and affixing the baggage tag to the bag; on delivery of the baggage to a passenger's cabin: scanning a location identifier in the region of the cabin with a scanning device and notifying the passenger via a mobile application stored on the passenger's mobile device that the baggage has been delivered to their cabin, and updating the baggage message with the status of the bag; prior to arrival at a destination port: collecting the baggage from a passenger's cabin, scanning the baggage tag and updating the status of the baggage message; and on unloading of baggage at a port: sending a message to the mobile device of the passenger associated with the baggage via the mobile application notifying them where to collect the baggage.

Preferably, prior to embarkation of the passenger onto the cruise ship, the baggage tag is scanned with a scanning device to read the unique identifier, validate the unique identifier against the stored baggage message to enable check-in of the baggage and updating of the baggage message.

Preferably, on collecting the baggage from a passenger's cabin, a message is sent to a passenger's mobile device via the mobile application informing the passenger that their baggage has been collected for debarkation.

Preferably, on collection of the baggage from a passenger's cabin, the baggage is loaded into a baggage container, a baggage container identifier is scanned and associated with the baggage, and an updated baggage message including the association is sent.

Preferably, on unloading of the baggage containers at a port: for a given item of baggage, the baggage container identifier in which the item of luggage is held and the baggage tag of the item of baggage are scanned with a scanning device, the associated baggage container identifier is retrieved for the item of baggage and a determination is made whether the retrieved identity matches the scanned baggage container identifier.

Preferably, on departure of the passenger from the port, the item of baggage is scanned and the status of the baggage in the baggage message is updated to indicate that the baggage has left the port.

The invention also resides in a system for tracking baggage on a cruise ship, comprising: a processor adapted to generate and associate for an item of baggage a unique baggage identifier with a unique passenger identifier to form a unique identifier, the passenger identifier being retrieved by the processor from a reservation system; the processor further adapted to generate and store a baggage message including the unique identifier in a data store; and to generate a baggage tag including the unique identifier for affixing to the bag; a scanning device for scanning a location identifier arranged in the region of the passenger's cabin, the scanning device including software for notifying the passenger via a mobile application stored on the passenger's mobile device that the baggage has been delivered to their cabin, and for updating the baggage message stored in the data store with the status of the bag; a scanning device for scanning the baggage tag prior to arrival in a port having software for updating the status of the baggage message; and a communications device for sending to a mobile device of the passenger, on unloading of baggage at a port, a message notifying the passenger where to collect the baggage.

One aspect of the invention provides a method of tracking baggage loaded onto a cruise ship, comprising the steps of: for an item of baggage, generating and associating a unique baggage identifier with a unique passenger identifier to form a unique identifier, the passenger identifier being retrieved from a reservation system; generating and storing a baggage message including the unique identifier; generating a baggage tag including the unique identifier and affixing the baggage tag to the bag; prior to embarkation of the passenger onto the cruise ship: scanning the baggage tag with a scanning device to read the unique identifier, validating the unique identifier against the stored baggage message to enable check-in of the baggage and updating the baggage message; and following boarding of the passenger and on delivery of the baggage to a passenger's cabin: scanning a location identifier in the region of the cabin with a scanning device and notifying the passenger via a mobile application stored on the passenger's mobile device that the baggage has been delivered to their cabin, and updating the baggage message with the status of the bag.

Another aspect of the invention provides a method of tracking baggage offloaded from a cruise ship at a port comprising the steps of: prior to arrival at a destination port, scanning the baggage tag and updating the status of the baggage message; loading the baggage into a baggage container, scanning a baggage container identifier and associating the baggage container identifier with the baggage and sending an updated baggage message including the association; on unloading of the baggage containers at a port: for a given item of baggage, scanning the baggage container identifier in which the item of luggage is held and the baggage tag of the item of baggage with a scanning device, retrieving the associated baggage container identifier for the item of baggage and determining whether the retrieved identity matches the scanned baggage container identifier; and on departure of the passenger from the port: scanning the item of baggage and updating the status of the baggage in the baggage message to indicate that the baggage has left the port.

A further aspect of the invention provides a method of tracking baggage on a cruise ship, comprising the steps of: for an item of baggage, generating and associating a unique baggage identifier with a unique passenger identifier to form a unique identifier, the passenger identifier being retrieved from a reservation system; generating and storing a baggage message including the unique identifier; generating a baggage tag including the unique identifier and affixing the baggage tag to the bag; prior to embarkation of the passenger onto the cruise ship: scanning the baggage tag with a scanning device to read the unique identifier, validating the unique identifier against the stored baggage message to enable check-in of the baggage and updating the baggage message; prior to arrival at a destination port: scanning the baggage tag and updating the status of the baggage message; loading the baggage into a baggage container, scanning a baggage container identifier and associating the baggage container identifier with the baggage and sending an updated baggage message including the association; on unloading of the baggage containers at a port: for a given item of baggage, scanning the baggage container identifier in which the item of luggage is held and the baggage tag of the item of baggage with a scanning device, retrieving the associated baggage container identifier for the item of baggage and determining whether the retrieved identity matches the scanned baggage container identifier; on departure of the passenger from the port: scanning the item of baggage and updating the status of the baggage in the baggage message to indicate that the baggage has left the port.

Embodiments of the invention have many advantages over the prior art. For example, they provide for greatly increased security over that which is available at present on cruise liners. Unlike existing systems, embodiments of the invention enable the cruise operator to know exactly how many bags are on board the ship and each bag has a unique identifier. At present, bags on cruise ships have a label which identifies the passenger name, cabin number and cruise but there is no central recordal of that information. Embodiments of the present invention provide a unique identifier which links a bag to and individual passenger in a manner that can be read and accessed centrally by an administrator.

Embodiments of the invention also increase security with respect to potential smuggling and terrorist offences. The existing system of issuing labels to passengers is open to abuse as labels may easily be copied. Embodiments of the present invention enable a manifest to be kept that links bags to passengers. As this information is captured as the passengers embarks, bags can be validated before departure and rogue bags eliminated.

Embodiments of the invention may have the advantage of providing a low cost and robust tracking system for environments having limited infrastructure or resources. Embodiments of the invention avoid the need for high cost tracking equipment.

Embodiments of the invention have the advantage of providing baggage tracking solutions in the cruise ship environment where there is often limited infrastructure. For much of a cruise a ship is out of high bandwidth communication with the shore and the ability to send baggage related messages is very limited. Embodiments of the invention overcome this problem by only requiring communication with land or cloud based systems when the ship is at or near a port.

Embodiments of the invention have the further advantage of providing full visibility to the cruise operator of the bags that have been loaded onto the ship. This enable the operator to plan how best to move baggage around the ship in a way that most suits passengers. Moreover it enables efficient planning at destination ports as the operator knows precisely how many bags have to be unloaded enabling the port operator to staff accordingly.

In some embodiments the baggage identifier fixed to the baggage may a bag tag, an RFID or a BLE beacon. The or each location identifier may be a bar code or a GPS module. The location information mat include a location code, a location text descriptor, or GPS/latitude and longitude coordinates.

The passenger identifier may comprises passenger related data retrieved from a passenger name record stored in the reservation system.

In one embodiment of the invention the item of baggage may be identified in the bag message as being unknown. This has the advantage of enabling the baggage tracking system to be integrated with airline baggage tracking systems even if the item of baggage is unknown in the airline context.

In one embodiment the steps of scanning are performed by one or more hand held scanning devices and/or by a scanning app running on a mobile communications device. Different types of scanning device and method may be used at different scanning points.

The step of generating a baggage tag may comprise generating the baggage tag electronically and sending the baggage tag electronically to the passenger. The step of updating the baggage message may comprise changing the status of the item of baggage in the baggage message.

In one embodiment, the step of updating the baggage message comprises generating and saving a new baggage message, the new baggage message having a different baggage status from the previous baggage message.

Embodiments of the invention may comprise, on boarding the ship, the passenger scanning a touchpoint with a scanning app loaded on a mobile communications device, and communication a signal to update the status of the baggage message permitting delivery of the passenger's bags to their cabin.

In one embodiment, scanning of the baggage tag prior to arrival at a port and prior to loading of the baggage into a baggage container comprising sending a message indicating that the item of baggage is in the possession of the cruise operator.

In one embodiment, after associating the baggage container identifier with the baggage and sending an updated baggage message including the association, a message is sent to the passenger's mobile communications device indicating the identity of the baggage container.

In one embodiment, the step of determining whether the retrieved identity matches the scanned baggage container identifier comprises, where the determination is that there not a match, sending an error message to the scanner operator indicating that there is no match.

### DETAILED DESCRIPTION

Embodiments of the invention will now be described, by way of example only, with reference to the accompanying drawings, in which:

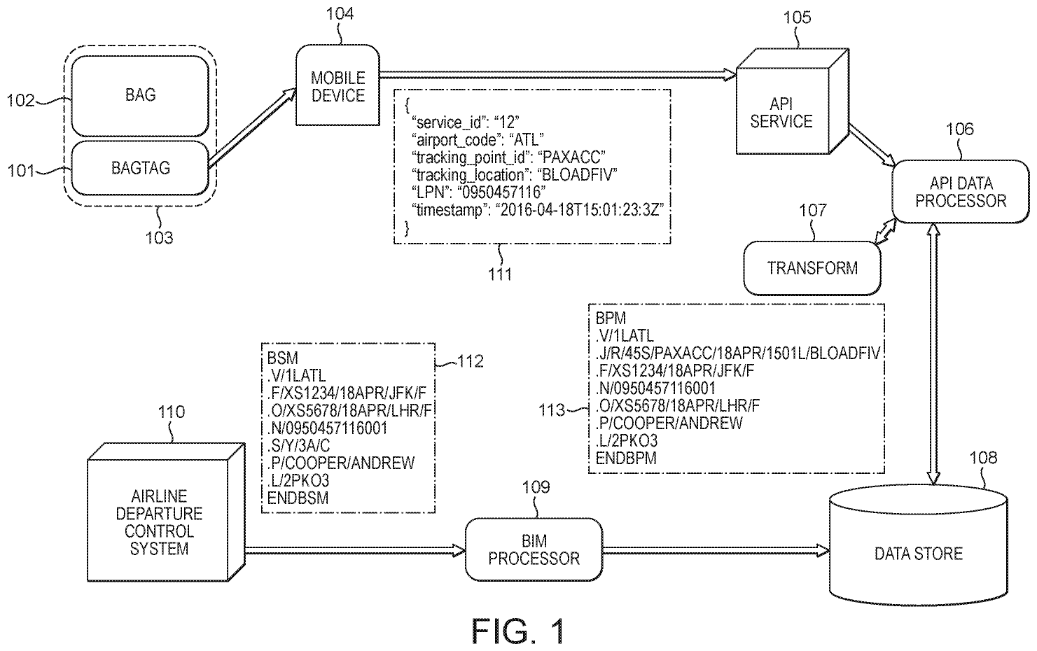

FIG. 1 shows a schematic diagram of a mobile tracking system;

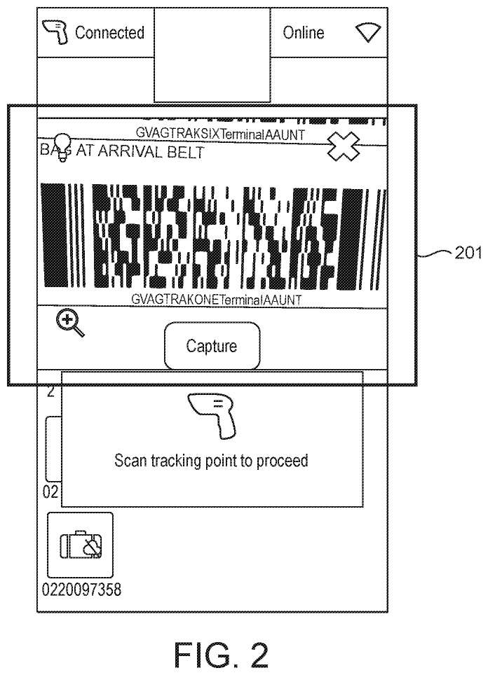

FIG. 2 shows an example graphical user interface (GUI) displaying a location barcode preview;

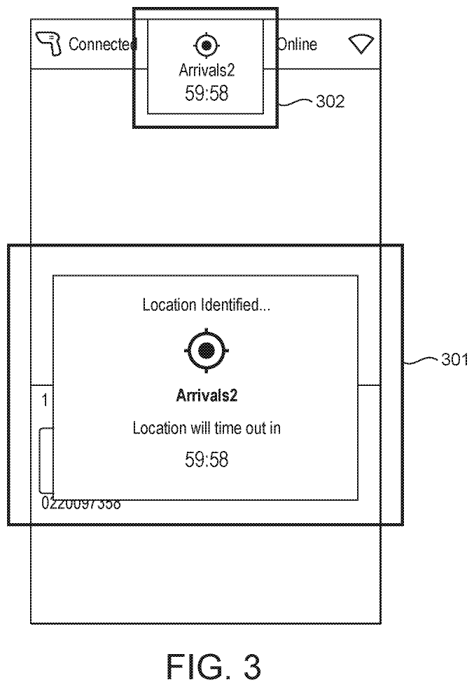

FIG. 3 shows an example GUI displaying a location notification;

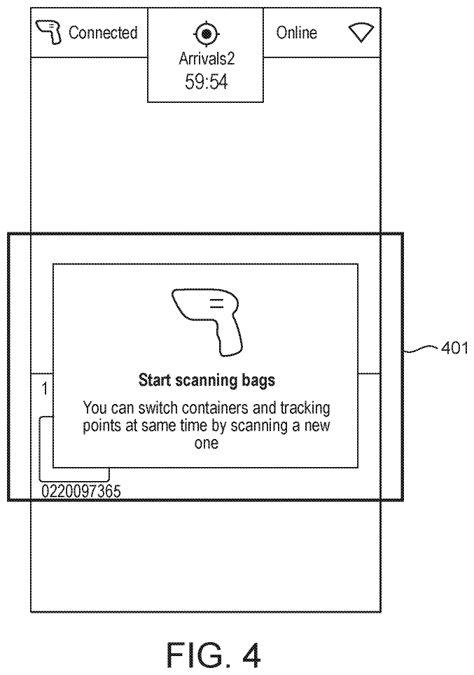

FIG. 4 shows an example GUI displaying a notification that a user may begin obtaining article information by scanning an article identifier;

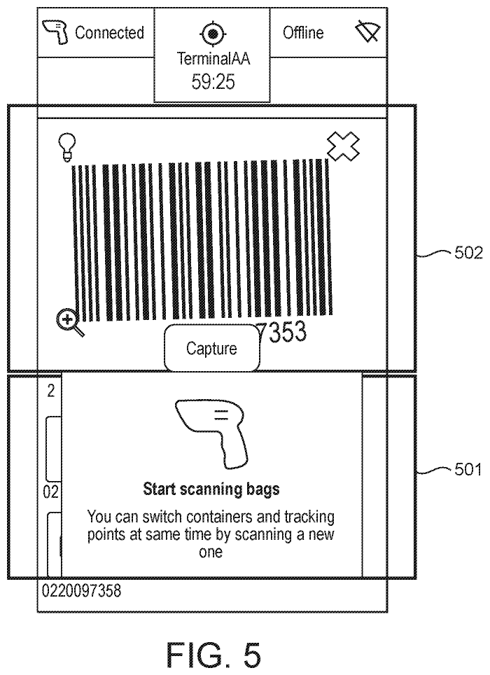

FIG. 5 shows an example GUI which displays a scanner preview window in addition to the notification that a user may begin scanning an article identifier;

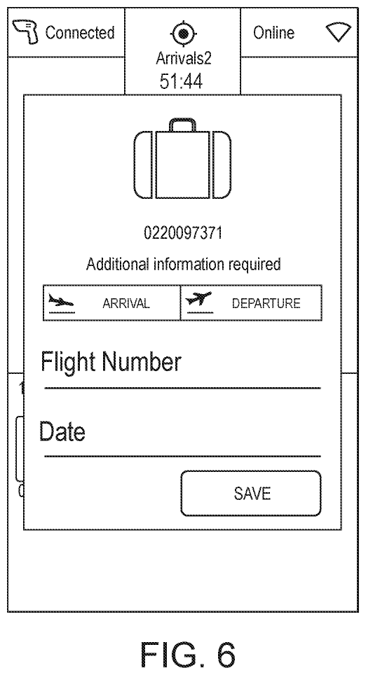

FIG. 6 shows an example GUI which displays a request for additional information related to the article being scanned;

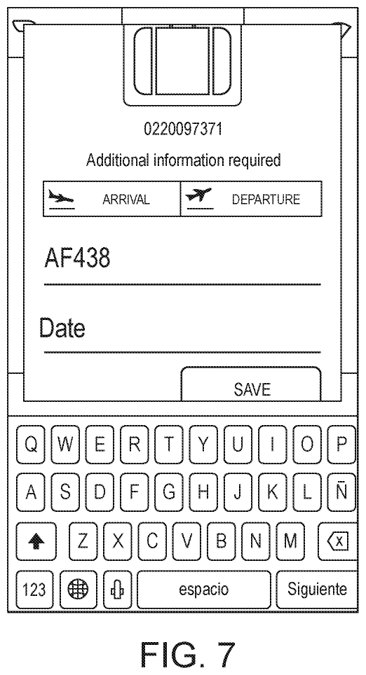

FIG. 7 shows the example GUI of FIG. 6, including additional information related to the article being scanned;

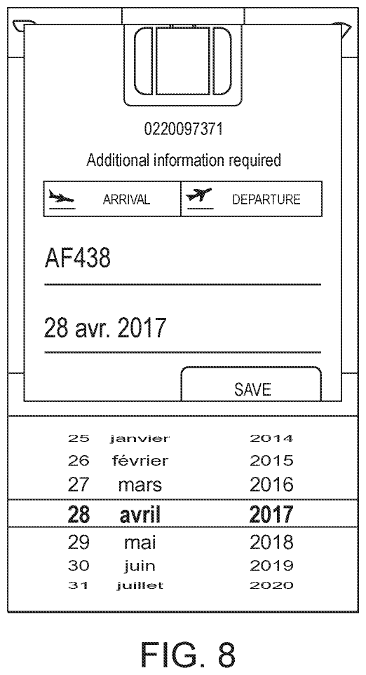

FIG. 8 shows the example GUI of FIGS. 6 and 7, including further additional information related to the article being scanned;

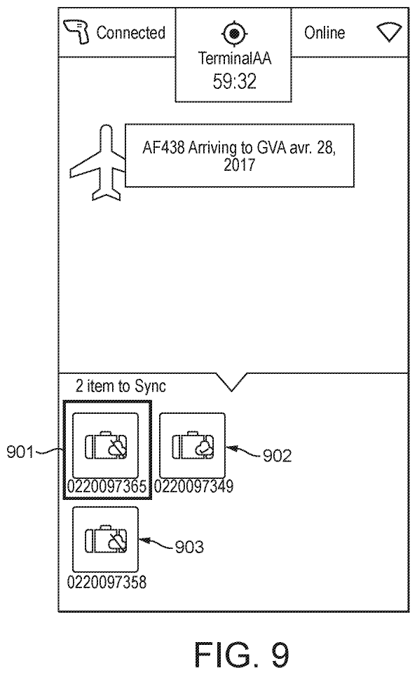

FIG. 9 shows an example GUI which displays scanned articles that have been provided with the additional information of FIG. 8;

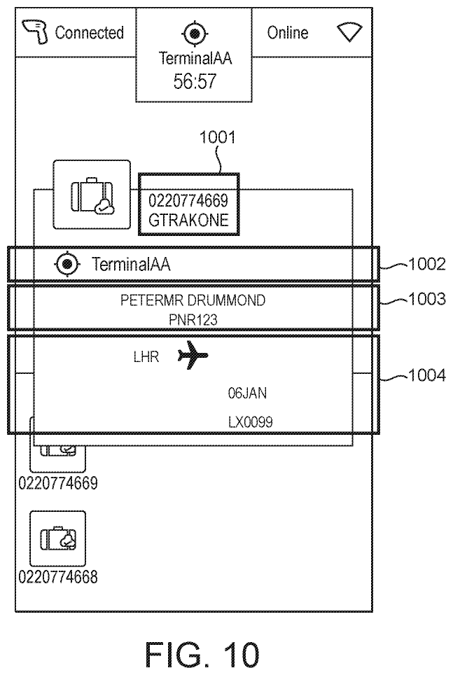

FIG. 10 shows an example GUI which displays information associated with a first article;

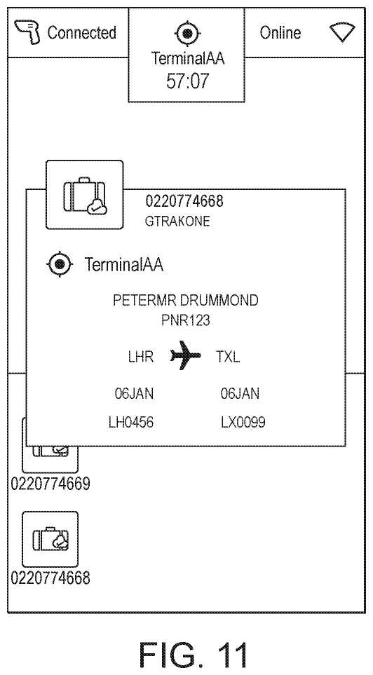

FIG. 11 shows an example GUI which displays information associated with a second article;

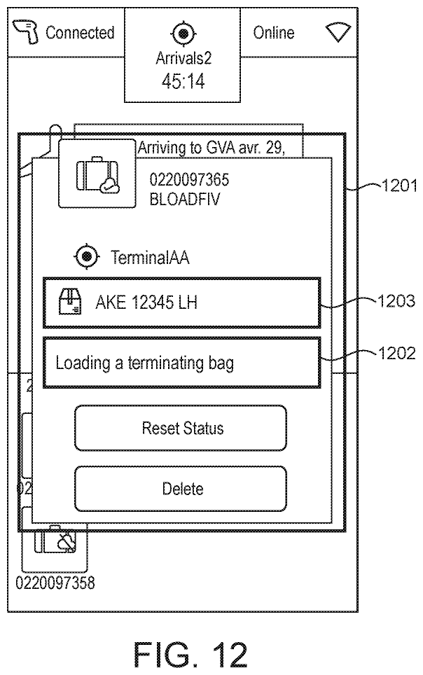

FIG. 12 shows an example GUI which displays information associated with a third article;

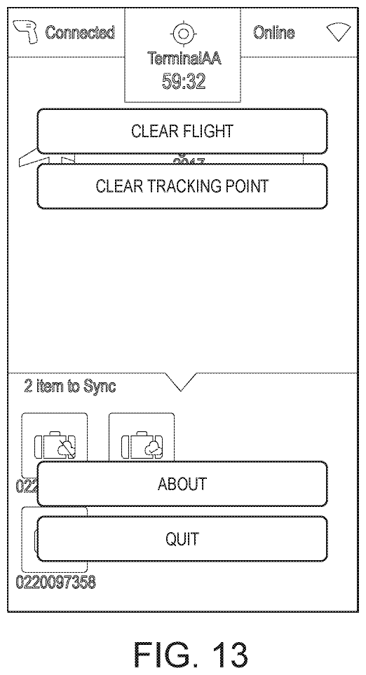

FIG. 13 shows an example GUI which displays options to clear data stored by the mobile application;

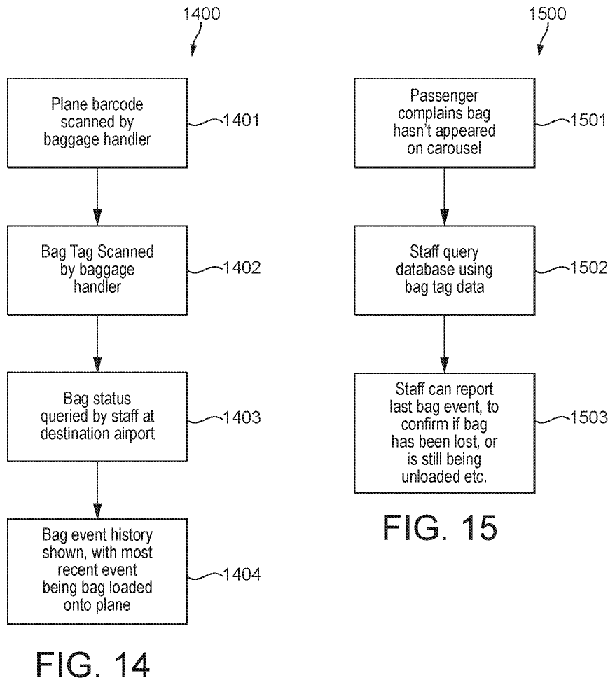

FIG. 14 shows a first schematic flow diagram for a user obtaining tracking history of an article;

FIG. 15 shows a second schematic flow diagram for a user obtaining tracking history of an article;

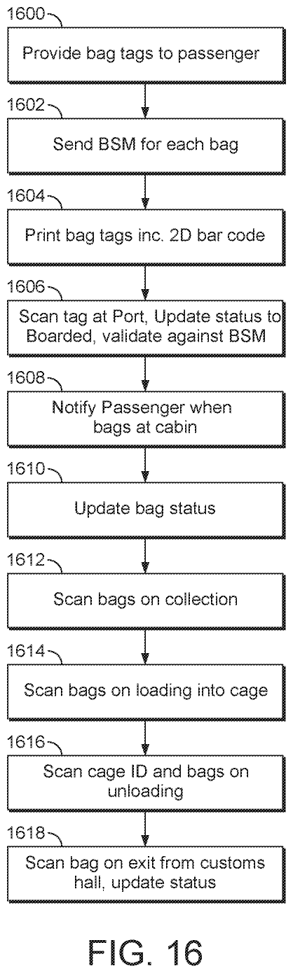

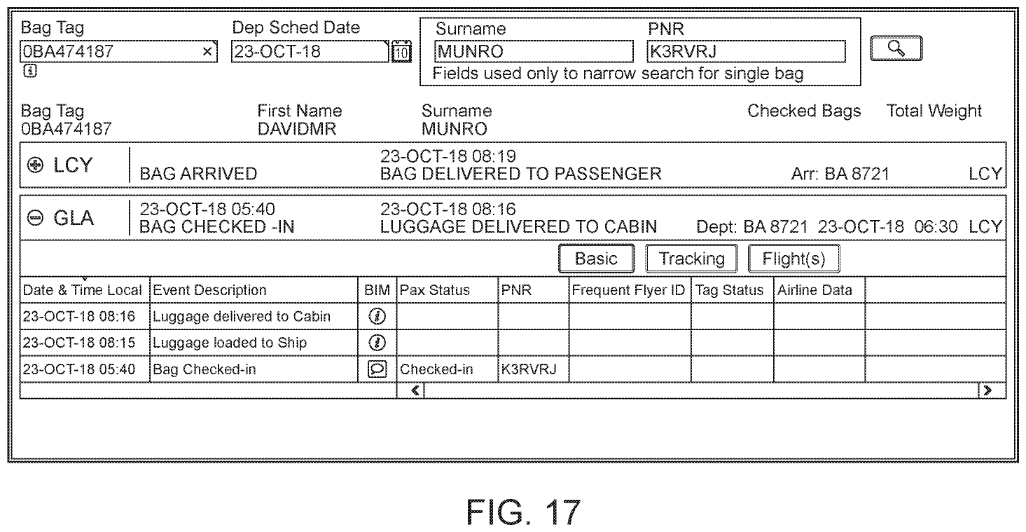

FIG. 16 is a flow chart illustrating steps in an embodiment of the invention;

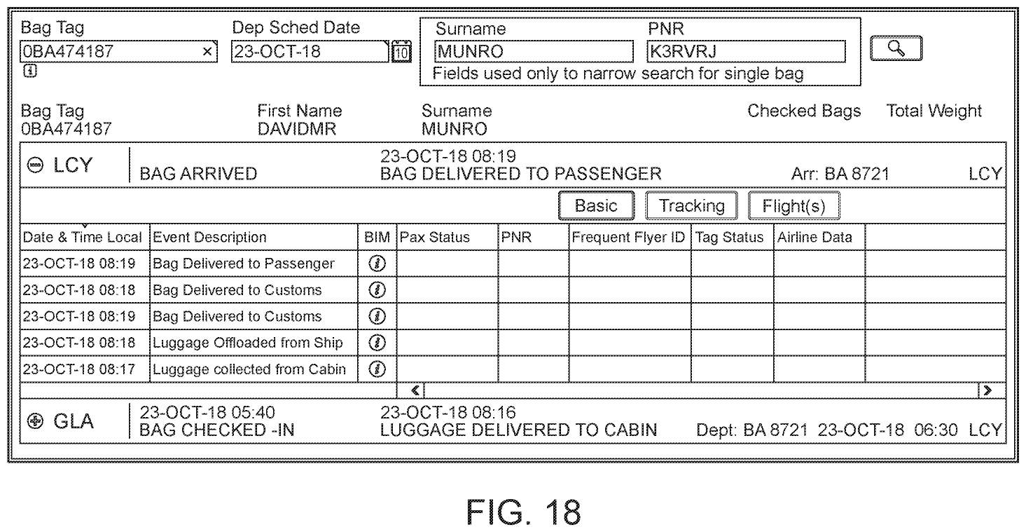

FIG. 17 is a screen shot showing a central record of the embarkation process: and

FIG. 18 is a similar screen shot to FIG. 17 showing the disembarkation process.

Within the cruise ship industry there are presently few solutions available for ensuring that the correct bags are loaded onto the correct ship. Moreover there are no provisions for the counting of bags or the correlation of bags. Thus although the cruise company may know that a passenger has checked in bags, they may not know how many. This can lead to confusion and in some cases, the cruise company being unable to determine whether they have mislaid one or more bags of a passenger. It also poses security concerns.

Once bags have been handed over by a passenger, the cruise company presently has no mechanism for informing the passenger where the bags are located. Some bags will be with the passenger in their cabin while others will be in storage in one of a number of holds. As cruise ships increase in size and passenger capacity this becomes an ever increasing problem. The largest cruise ships can carry over 6000 passengers.

At the end of a voyage, baggage reconciliation is a problem. Typically on arrival, bags are unloaded and then arranged on the quay in deck order. Passengers have to search for their own bags from all the bags for their deck. Even in the absence of errors in the relevant decks, this is a slow and laborious process. It is inconvenient both for the passengers and the port operator. As the size of cruise ships increases, quay side space also becomes limited.

The system described below addresses these problems and uses a series of messages known in the aviation industry for baggage handling. These messages, known as BIMs (Baggage Information Messages) include BSMs ((Baggage Source Messages) and BPMs (Baggage Processed Messages). In the detailed example below, the BSM is described in detail in relation to a bag whose identity is known. However the BSM can also be used to describe a bag of unknown origin. In an embodiment of the present invention, this message format is used for bags that relate to a cruise ship. They are unknown in the sense that they are unknown only in the aviation environment.

Before describing the application of the BSM to the cruise ship industry there will first be described a method and system which utilises BSMs for baggage tracking in the airline industry. The application of this system to the cruise line industry will then be described.

Presently, bags are tracked in the airline industry using 1-d laser barcode scanners and Baggage Information Messages (BIMs), which are sent between departure control systems and automated baggage handling systems. The BIMs are sent, received and processed by the airport departure and baggage handling systems in order to achieve automated baggage sortation, passenger and baggage reconciliation, and other baggage services.

Bag information included in the BIMs is linked with a 10-digit bag tag number defined as the License Plate Number (LPN). This 10 digit LPN is issued during check-in and is used to create a unique reference to a specific bag. The airport systems receive this 10 digit LPN in a baggage message and store the LPN for use as a reference when communicating to other airport systems. The LPN is represented on the 1-d laser barcode issued for a checked bag.

There are several different types of Baggage Information Messages, including Baggage Source Messages (BSMs) and Baggage Processed Messages (BPMs).

The BSM provides information for processing baggage by automated baggage systems. For example, a BSM will be generated by an airline Departure Control System when a passenger checks in a bag for a journey, when a bag must be transferred to a different flight, and when a bag has been mishandled.

An example of a BSM in teletype format is shown below. Data contained within the BSM may be sourced from baggage handling systems, or other systems storing passenger information.

| MESSAGE CODE LINE | MESSAGE LINE DESCRIPTION |
|---|---|
| BSM<≡ | Standard Message Identifier |
| .V/1LZRH<≡ | Version 1; Local baggage at Zurich |
| | Airport (ZRH) |
| .F/BA101/18APR/JFK/F<≡ | Outbound carrier and flight; Date; |
| | Destination; Class |
| .N/012523456003<≡ | LPN-IATA airline code; Baggage number |
| | (underlined); Number of consecutive tags |
| ENDBSM<≡ | End of Message Identifier |

In the above example the second line, which begins .V, defines the current location of the bag, Zurich, and indicates the bag has originated there.

The third line, which begins .F, defines the itinerary. In this case, a bag has been checked onto British Airways flight number BA101 to JFK International Airport on 18 April and belongs to a first class passenger. Itinerary data is mandatory in BSMs for originating baggage, as in the above example, and transfer baggage. It is not included for a bag which has reached its terminating location.

In the fourth line, .N indicates the baggage LPN and the number of checked in bags belonging to the same traveller. The 1st digit is a leading digit which may be used by individual airlines to aid baggage identification. The 2nd to 4th digits (085) define a 3-digit IATA airline code. For example, 006 indicates Delta Airlines and 125, the example here, indicates British Airways. The 5th to 10th digits (underlined above) define a 6-digit baggage number associated with the bag at check-in. The final 3 digits indicate that 3 bags were checked in by the passenger. Thus, 3 LPNs are associated with this passenger:
LPN#1=0125123456
LPN#2=0125123457
LPN#3=012523458.

The 6-digit baggage numbers are generated in sequential order and combined with a 3-digit IATA airline code and a customisable leading digit to create an LPN. Due to the large volume of passengers, airlines must reuse existing LPNs, and so a bag is uniquely identified by combining the date of travel with the ten digit LPN. Thus the LPN combined with the date of travel is an example of a unique baggage identity which is encoded in a bag tag which is an example of an article identifier.

BSMs are sent to provide information for processing of baggage by automated baggage systems. For example, a BSM may be sent when a bag tag is deleted, a bag is re-routed or a passenger's itinerary is changed.

BPMs are sent to communicate when a bag has been processed by a baggage handling system. For example, a BPM may be sent when the baggage handling system reports that a bag has missed a connection. BPMs come in two varieties: sortation messages and reconciliation messages. As before with BSMs, the data contained within a BPM may be sourced from baggage handling systems, or other systems storing passenger information.

BPM sortation messages are sent during various stages of the bag journey and enable baggage sortation systems to determine whether a bag has been correctly sorted. The sortation messages also include screening messages. Baggage screening systems are used by Transport Security Agents (TSAs) to check baggage, and a BPM is generated if the bag is approved.

BPM reconciliation messages are confirmation messages sent when a bag successfully completes part of the bag journey. For example, a BPM reconciliation message may be sent when a bag is correctly loaded onto or unloaded from an aircraft.

Embodiments provide an article scanning and tracking system using a multi-protocol API connected to a cloud platform via a network. Where the article is an item of baggage, the system can be used for remote baggage tracking, as further described below.

As shown in FIG. 1, a system 100 embodying the invention includes: a bag tag 101 associated with a bag 102 to form a tracked article 103; a mobile device 104; a cloud platform comprising an API Service 105, an API Data Processor 106, a Transform service 107, a Data Store 108, and a Baggage Information Message (BIM) Processor 109; and an Airline Departure Control System (DCS) 110. The mobile device 104 includes a mobile application for communicating with the API service.

During the check in process, the Airline DCS 110 sends messages 112 including passenger-related information to the BIM processor 109 and for storing in a data store as a passenger name record (PNR). Embodiments enable bag location information to be amalgamated with existing PNR data by sending messages 111 including bag location information from the mobile device 104 to the cloud platform via the API service 105, as further described below. A message 113 is generated including tracking information and passenger-related information and stored in data store 108. Providing the functionality of the API on a mobile application allows an airport to provide bag scanning and tracking functionality using a mobile device, thereby reducing the costs and infrastructure requirements for tracking a bag.

When a bag 102 is checked in, the airline generates a paper bag tag 101 which includes a license plate number (LPN) associated with the baggage article. The check-in event generates a Baggage Source Message (BSM) in the airline's Departure Control System (DCS) 110. The example BSM 112 shown in FIG. 1 is detailed below.

BSM
.V/1LATL
.F/XS1234/18APR/JFK/F
.O/XS5678/18APR/LHR/F
.N/0950457116001
.S/Y/3A/C
.P/COOPER/ANDREW
.L/2PKO3
ENDBSM

In the above example, the BSM 112 provides the following passenger-related information and instructions for ground handlers.

“.V/1LATL” provides version information, including the source of the baggage article and the airport the BSM was generated at. In this example, the BSM 112 was generated at Atlanta airport and the bag 102 is local, i.e. it has not been transferred from elsewhere.

“.F/XS1234/18APR/JFK/F” provides flight information, including flight number, the date of the flight, the destination airport and seat class. In this example, the bag 102 is associated with a passenger travelling on flight XS1234 on 18 April to John F. Kennedy International Airport with a First Class seat.

“.O/XS5678/18APR/LHR/F” provides information relating to any onward or connecting flights, including the onward flight number, onward flight date, destination and seat class. In this example, the bag 102 needs to be loaded onto connecting flight XS5678 on 18 April to London Heathrow Airport.

“.N/0950457116001” provides the bag tag information, which includes a 10 digit LPN and the number of articles checked in by the same passenger. In this example, the LPN is 0950457116 and only one bag 102 was checked in by the passenger.

“.S/Y/3A/C” provides baggage reconciliation information, including whether a bag 102 is authorised to be loaded, the passenger's seat number and the passenger's status. In this example, the bag is authorised to be loaded onto the plane, the passenger has checked in and will be seated in seat 3A.

“.P/COOPER/ANDREW” provides passenger name information.

Finally, “.L/2PKO3” provides passenger name record (PNR) address information.

The BSM 112 containing the above information is sent to the cloud platform via message routers from the Airline DCS 110 and is processed by a BIM Processor 109. The BIM processor 109 stores the baggage event in the cloud Data Store 108. Accordingly, the Data Store 108 contains a record of the information provided by the BSM 112.

After check-in, the bag tag 101 associated with the bag 102 may be scanned by the mobile device 104 at various scan locations. In some embodiments, the scan locations define points of interest on a bag journey. For example, a point of interest on a bag journey may be a plane-side loading point where baggage is stored before being loaded onto an aircraft.

Scanning the bag tag 101 with the mobile device 104 retrieves the LPN associated with the bag 102 from the bag tag 101. In preferred embodiments, the mobile application generates a message 111 including article information related to the bag and location information related to the current location of the bag and sends the message to the API service 105 via the network. Alternatively, the message 111 may be delivered to the API service 105 via WIFI, 3G, LTE or any other wireless connectivity means.

In preferred embodiments, the article information is electronically readable to enable the mobile device to obtain the article information. For example, article information may be obtained by scanning an article identifier. The article information included in the message 111 preferably contains the LPN which functions as a unique bag identity. Similarly, location information related to the current location of a bag may be obtained from a location identifier associated with a point of interest on a bag journey using the mobile device. In a specific example, the identifier may be a tracking location barcode placed at a key location during a bag journey which is scanned by the mobile device. For example, a location barcode may be placed next to each arrivals carousel.

An example format of a tracking location barcode is:
AAAEEEEEEEELLLLLLLLLLUCT

In the above example, “AAA” is an airport code. “EEEEEEEE” is an 8 character event type, which is passed to the API as “tracking_id.” “LLLLLLLLLL” is a 10 character location, which is passed to the API as “tracking_location.” “U” is an instruction for an unknown bag. The instruction may be to ignore the unknown bag or to input flight data. “c” is a container input instruction. In some circumstances, a further barcode reading of a container ID is required after scanning a tracking point. “T” is the type of scan event to be performed. For example, the scan event may be loading or tracking.

In alternative embodiments, the identifier associated with a point of interest may be encoded in a short-range radio signal located at the point of interest.

Enabling the mobile device to scan the bag tag associated with a bag and the identifier associated with a point of interest enables accurate tracking information to be sent to the cloud platform API service 105 via an API payload. The example API payload 111 of FIG. 1 is detailed below.

{
″service_id″: ″12″
″airport_code″: ″ATL″
″tracking_point_id″: ″PAXACC″
″tracking_location″: ″BLOADFIV″
″LPN″: ″0950457116″
″timestamp″: ″2016-04-18T15:01:23.3Z
}

In the above example, “service_id” defines the unique identification number which may be associated with a particular third party such as a customer or contractor. Including “service_id” enables the system to verify that requests or calls to the cloud system are from a known source. “airport_code” defines the airport where the LWBIM was generated. In this example, the airport is identified as Atlanta airport. “tracking_point_id” defines the type of baggage handling event being recorded, and may be associated with a text descriptor. In this example, “PAXACC” may be matched against an internal event code, which indicates that a passenger has accepted the bag at baggage reclaim. “tracking_location” defines the location of where the scan occurred. The tracking location, “BLOADFIV” in this example, may be associated with a location descriptor, “B Load Five” in the present example, or GPS coordinates. “LPN” defines the license plate number and “timestamp” defines the time that the scan was made.

In alternative embodiments, location information could be GPS coordinates provided by a GPS module of the mobile device, or the location information could be manually input by a user.

The API payload 111 including the bag information may be sent to the cloud platform as a lightweight baggage information message (LWBIM). In a specific embodiment, the API payload 111 is a LWBIM in JavaScript Object Notation (JSON) message format, as shown in the example API payload 111 above.

The cloud platform identifies the LPN from the LWBIM 111 and enriches the payload using the API Data Processor 106. In specific embodiments, the API data processor 106 requests passenger-related information associated with the LPN contained in the LWBIM 111 from the PNR database in Data Store 108. If any passenger-related information is retrieved from the PNR database then the LWBIM is enriched with the passenger-related information by the API Data Processor 106. For example, the cloud platform may retrieve flight information or historical location information from the Data Store 108.

To enable compatibility with legacy systems, the enriched LWBIM is converted into a BIM 113 by Transform service 107. Thus, the BPM contains tracking information received via the API service and passenger-related information via an external system such as the baggage handling system. The cloud platform then processes and stores the BIM 113 as part of a message chain associated with the bag in Data Store 108. This enables the cloud platform to serve requests by parties for the status of the bag at a particular stage during a journey.

Including location information enables the cloud platform to cross-reference the scanned information with information located in a Data Store 108. The LWBIM 111 may then be augmented with additional related information retrieved from the Data Store 108. In some embodiments, the retrieved additional related information includes stored physical location data associated with this location for reporting within the mobile application.

As mentioned above, legacy Airline Systems typically use teletype format messages. If compatibility with legacy systems is required, the LWBIMs, which may be in JSON format, must be converted into a BIM in teletype format as further described below.

First, the API Service 105 accepts the LWBIM message 111 and sends it to the API Data Processor 106. Secondly, the API Processor 106 retrieves information associated with the baggage article 102, including flight information, from the Data Store 108. This is done by using the LPN information included in the LWBIM 111. The API Processor 106 enriches the LWBIM 111 with the data returned from the Data Store 108 and sends the enriched event to the Transform service 107. In a final step, the Transform service 107 transforms the JSON format LWBIM 111 into a teletype BPM 113. Thus, the BPM 113 generated by the Transform service 107 is compatible with external legacy systems and includes baggage location data and passenger information data. The BPM 113 is returned to the API Data Processor 106 and sent to the Data Store 108 to be stored as a new baggage event. BPMs are industry-standard messages which are used by numerous legacy airline systems, such as departure control systems and automated baggage handling systems. Generating a BPM including article location information therefore enables embodiments to provide article tracking data to existing legacy systems or other third parties.

The example BPM 113 generated by the Transform service of FIG. 1 is detailed below.

BPM
.V/1LATL
.J/R/45S/PAXACC/18APR/1501L/BLOADFIV
.F/XS1234/18APR/JFK/F
.U/AKE67890LH
.N/0950457116001
.O/XS5678/18APR/LHR/F
.P/COOPER/ANDREW
.L/2PKO3
ENDBPM

The API data processor matches the LPN provided by the LWBIM 111 with the LPN associated with known passenger-related data detailed in the BSM 112 sent by the baggage handling system. The Transform service 107 is therefore able to include incoming and onwards flights details, if such details exist, into the BPM. The .J element includes tracking data gathered by the mobile application and sent via the LWBIM 111, such as “tracking_id” and “tracking_location.” The BPM 113 may also include a container identifier, if such data has been collected, in the .U element (not shown in FIG. 1). In the above example, the container is identified as “AKE 67890 LH”.

In some instances, the API Data Processor 106 is unable to retrieve passenger related data from the data store 108 as there is no BSM associated with the particular LPN. This situation may occur if a particular airline has a problem with their network, or if smaller airports do not have access to the baggage handling systems. If passenger related data cannot be retrieved, then the mobile application will issue a prompt for the passenger related data, such as flight number and date of travel, to be entered manually as further described below.

Once written to the Data Store 108, the well-known concept of shadowing may be used to accumulate all the tracking data associated with a bag 102.

A ‘shadow’ is a software copy of the physical bag tag containing a store of all historical data associated with the bag tag. The shadow may be stored in a cloud-based database and persists even if the system software crashes. The shadow can be replicated for use across different operating systems or hubs. The shadow may be queried to identify a particular bag tag and can return any historical data concerning the baggage article associated with that bag tag, including the most recent location data and LPN.

The shadow therefore contains a full history of the bag's tracked location. A location tracking system could therefore interrogate the shadow, extract the stored tracking data associated with a bag and present the data to a user in a meaningful way.

In an embodiment, the mobile application may send a notification to a passenger when a bag arrives at a specific location. For example, a notification may be sent when the bag arrives at a holding area to await being loaded onto an aircraft. The notification may include information relating to the bag's location and the time of arrival at that location. The notification may also include other information such as passenger details, the flight number and final destination.

Further aspects of the invention may be embodied in a mobile application for use in the above described system. Embodiments enable the mobile application to create API payloads 111 including bag information and send the API payloads 111 to cloud platform API service 105. Embodiments also enable the mobile application to query the cloud platform about a bag's location history. In preferred embodiments, the mobile application is loaded onto a mobile device 104 having a scanning module and, in specific embodiments, the scanning module is a camera.

FIGS. 2 to 14 show an example graphical user interface (GUI) for a mobile application which may record and retrieve baggage tracking information.

To record bag location data, the mobile application prompts a user to enter a location. In some embodiments, the bag location may be entered by scanning a tracking point identifier, as shown in FIG. 2. In this case, the GUI displays a preview of the tracking point identifier, as viewed by the scanning module, to enable a user of the mobile application to successfully scan the tracking point identifier.

In the embodiment shown in FIG. 2, the tracking point identifier is a 3 dimensional barcode 201. However, in alternative embodiments, the location information may be provided by any other suitable means, for example receiving a payload from a Bluetooth® beacon, scanning an RFID, or obtaining the current GPS coordinates of the mobile device.

Scanning the tracking point identifier provides the mobile application with location information for associating with a bag to be scanned. If the mobile device successfully identifies the current location, a notification 301 may be displayed by the GUI. In the example shown in FIG. 3, the GUI identifies the current location as arrivals belt “Arrivals2.” Displaying text descriptor of the current location may enable a user to quickly identify whether the scanned location correctly corresponds to their current location. The text descriptor may also be used as a placeholder for more detailed location information, such as GPS coordinates, by the cloud platform.

Once identified, the location information is valid for a limited period of time. In the example shown in FIG. 3, the location information is valid for approximately one hour. Any bag that is scanned within this time period will be associated with the current location, “Arrivals2.” The GUI displays an indicia 302 indicating the current location and the time remaining before the location information needs to be updated. Validating the location information for a limited period of time beneficially prevents a user from continually re-entering location information, while also preventing the application from retaining old location data, which may no longer be accurate.

Once the mobile application has been provided with valid location information, the scanning module of the mobile device scans a bag tag 101 associated with a bag 102. In the examples shown in FIGS. 4 and 5, the GUI may issue a notification 401 that a user may begin scanning bag tags. As shown in the example of FIG. 5, the GUI may display the notification to begin bag scanning 501 simultaneously with a scanner preview window 502 for enabling a user to align the scanner with a location identifier.

If a bag is known to the baggage handling system then the cloud platform may retrieve passenger-related information associated with the LPN of a particular bag from a BSM issued by the departure control system (DCS). There is therefore no requirement for a baggage handler to input the flight details for every bag that they process, hence advantageously saving time.

In some embodiments, the mobile application will be configured to request additional flight-related information. This may occur if passenger-related information associated with the baggage article being scanned cannot be retrieved, which occurs when the cloud platform does not contain a record of a BSM associated with a particular bag.

In that case, the mobile application detects that a bag is unknown on scanning the bag tag and will display a request for additional passenger-related information, as shown in the example of FIGS. 6 to 8. This step is only required when there is no record of the bag in the cloud platform. In the example shown in FIG. 6, the additional passenger-related information is the flight number and date of travel. FIGS. 7 and 8 show how the user may provide this information to the GUI. However, the additional information requested by the GUI may not always be passenger related. In some embodiments, the GUI may request more specific location information, for example if the baggage may be loaded into a choice of loading containers the GUI may issue a prompt to scan the unique identifier associated with the particular loading container.

The mobile application retains the manually inserted location information and additional flight-related information and associates that information with the LPN associated with any unknown bags. In the example shown in FIG. 9, three unknown bags have been provided with the same location and flight-related information, namely flight number AF438 to Geneva Airport on 28 Apr. 2017. Each scanned bag may be represented by a bag icon 901 which indicates the LPN associated with the bag to enable a user to distinguish between scanned bags and to correctly select a particular bag.

Once the mobile application has acquired the above bag information, the mobile application generates an API payload 111 including the bag information and attempts to send the API payload to the API service 105 via a network. As shown in FIG. 9, the GUI may indicate whether the payload 111 has been successfully uploaded to the API service 105 by marking the bag icon associated with the bag with a tick 902. If the mobile application has been unable to upload the information associated with the bag, then the relevant bag icon is marked with a broken cloud 903. Failure to upload the bag information may be due to an error synchronising the bag data with the server. If a record of the LPN associated with the bag already exists in the cloud platform then the API data processor 106 may retrieve passenger-related data associated with the LPN and generate a BPM from the bag information obtained from the API payload 111 and the retrieved passenger-related data.

As shown in FIGS. 10 to 12, the GUI may display information associated with a particular bag when a user taps on the relevant bag icon 901. In a first example shown in FIG. 10, the GUI displays information including the LPN and tracking location 1001, most recent location data 1002, passenger name data 1003, and flight-related data 1004. In this example, the GUI indicates that the LPN associated with the bag is 0220774669, the most recent location of the bag is “GTRAKONE”, which is situated in TerminalAA, the bag is associated with Mr Peter Drummond, and the bag will be travelling on flight LX0099 on 6 January. In a second example shown in FIG. 11, the GUI indicates that the LPN associated with the bag is 0220774668, the most recent location of the bag is “GTRAKONE” in TerminalAA, the bag is associated with Mr Peter Drummond, the bag has previously travelled on flight LH0456 on 6 January and will be travelling on flight LX0099 on 6 January.

If an error occurs during bag scanning, an error message is displayed by the GUI. In the example shown in FIG. 12, the error message 1201 includes text 1202 indicating that the bag is a terminating bag and should not be loaded onto the plane. The example shown in FIG. 12 also includes current location information 1203 which indicates the container that the bag has been loaded into. In the specific example shown in FIG. 12, the bag is loaded into container “AKE 12345 LH.”

The mobile application may enable a user to clear the location or flight information that is associated with each scanned bag at any time, as shown in FIG. 13. This enables a baggage handler to associate new location and flight information for bags associated with a different flight. These options may be accessed from a menu on the GUI.

The mobile application described above has the advantage of only requiring minimal data to be captured for a bag to be successfully recorded by a back end database.

Embodiments may be used to perform ‘bingo sheet’ scanning. Here, a plurality of bag tag bar codes are stuck to a sheet of paper and all the bag tags can be recorded in a single scan. Thus, the steps of generating a message by combining the article information with the location information; b. applying a timestamp to the message; and c. transmitting the timestamped message via a transmitter of the mobile device; can be performed sequentially for a plurality of bag tags in a very short time in a single scanning action.

The mobile application GUI described above has the advantage of having a minimalist design, enabling a handling agent to focus on moving and scanning bags without needing to input manual data, apart from in exceptional circumstances, as there is no need to navigate into menus or complex settings.

The above systems and methods may be used to enable a user to upload bag location information to a cloud platform, but may also be used to retrieve information from the cloud platform. For example, the mobile application can retrieve a status summary for the bags associated with a particular flight. Entering a particular flight number, for instance flight number “BA078”, would result in obtaining status information for the bags associated with that flight. This may be achieved by sending an API request for the relevant flight and location data stored in data store 108 associated with that flight number. The status summary may provide the number of bags check in for the flight, the number of transfer bags received from other carriers which are due to be loaded onto the flight, the number of bags loaded onto containers due to be loaded into the aircraft, and the number of bags already loaded into the aircraft. This advantageously enables bag handlers to know whether any more bags are expected at any given time.

The mobile application can also be used to retrieve information associated with a particular bag, as described below with reference to the schematic workflows of FIGS. 14 and 15.

FIG. 14 shows an example schematic workflow 1400 for a member of airport staff querying the location of a particular bag using the mobile application.

In a first step 1401, a location identifier is scanned by a baggage handler. In this example, the location barcode is located at a first airport and is associated with a point of interest on a bag journey. In the specific example shown in FIG. 14, the location identifier is a barcode located at a plane-side loading point. In a second step 1402, a bag tag is scanned by the baggage handler. As before, scanning the bag tag retrieves an LPN associated with the bag. The LPN and bag location information are amalgamated and sent to the cloud platform as described above. In a third step 1403, the bag status is queried by staff at the destination airport. In this example, a passenger's bag may have been sent to the wrong destination. When arriving at their destination airport, which may be different to the first airport, the passenger may ask a member of staff at the destination airport the current location of their bag. The member of airport staff at the destination airport may use the mobile application to request the location information using the passenger's LPN or other passenger-related data. In a final step 1404, the bag event history is shown, with most recent event being the bag loaded onto the plane. The cloud platform database may return additional information relating to the last known scan location, including a text descriptor of the scan point, the latitude and longitude GPS coordinates of the scan location, and the scan time. In this example, the member of staff would be able to use the mobile application and tracking system to provide some peace of mind to the passenger by correctly informing them that their bag has been loaded onto the next flight to the destination airport.

FIG. 15 also shows an example schematic workflow 1500 for a member of airport staff querying the location of a particular bag using the mobile application to inform a passenger of their bag status.

In a first step 1501, a passenger complains their bag has not appeared on a carousel. In this example, a passenger's bag may have arrived at the destination airport, but may have been misplaced on the way to the arrivals bag carousel. In a second step 1502, staff query the database using bag tag data. The airport staff may use the mobile application to search for bag location information associated with an LPN, or other passenger-related data. In a third step 1503, staff can report last bag event, to confirm if the bag has been lost, or is still being unloaded, etc. In this example, the member of staff would be able to use the mobile application and tracking system to provide current information to the passenger. This provides a degree of certainty to the passenger so that they may either continue to wait to reclaim their bag, or to notify another member of staff that their bag is lost.

Embodiments have the advantage of improving on currently available systems by simplifying the process of “on-boarding” tracking services at locations currently not served with adequately required infrastructure, as well as locations who wish to extend their tracking capabilities at significantly reduced cost and effort. It also provides the advantage of creating more “portable” tracking opportunities due to the light-weight nature of the interface and numerous network connectivity options. A further advantage is that the claimed invention interfaces with legacy technology. This allows “modern” aspects of the network, such as mobile-based scanning, to interface with existing legacy infrastructure and to make use of the information within the legacy systems.

In the air transport industry, there is a well measured anxiety about the possibility of checked baggage being lost, stolen, delayed, or damaged. Although these eventualities are rare, passengers remain unaware of the precise location and status of their baggage throughout much of their journey. Embodiments therefore have the advantage of reassuring passengers that their baggage has been processed properly by sending baggage status notifications to a passenger through a mobile application.

In another embodiment, the API Data Processor 106 may also send the generated BPM 113 to baggage handling systems or other systems storing passenger information. Sending BPMs to baggage handling systems enables embodiments to effectively communicate data associated with tracking a baggage article to existing systems.

The above detailed description of embodiments are not intended to be exhaustive or to limit the invention to the precise form disclosed. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Cruise Ship Application

Having described embodiments with respect to the airline industry, the following description explains how the system described above may be adapted for use in cruise ship applications. Reference is made to FIG. 16 which is a flow chart showing the steps in the process to be described.

At step 1600 the cruise operator provides bag tags having a 2D barcode to each passenger in advance of the voyage. A passenger may have a number of bag tags but the tags each include a unique passenger ID and a unique bag ID enabling each bag to be identified and tied to an individual passenger. The cruise operator then, at step 1602, generates and sends a Bag Source Message (BSM) to the departure control system 110 (FIG. 1). The DCS 110 is now replaced by a Cruise Reservation System but otherwise functions in the same way as the airline DCS 110. The BSM is in the form described above, but instead of indicating the flight details for which the bag is associated it will indicate that the baggage is unknown in the context of the aviation environment. The BSM will, however, indicate the name of the passenger, the cruise they are booked onto, the cabin number, booking reference, a unique ID, which is the LPN of the earlier example, and a timestamp. The cabin number may simply replace the seat number in the airline BSM example. In practice, when the message is originally sent it will include the LPN, time stamp and a tracking point id. The system replies with an unknown bag message as it will not correspond to a known flight in the system at which point a further message is sent which corresponds to flight details, on in this case cruise details, such as voyage number, date and type. The type might be an arrival or a departure indicator. If these details are not already known to the system a message is sent to the passenger asking them to input their details.

Table 1 below compares the fields in an airline message with those in the cruise message.

TABLE 1

| Airline Message | Cruise Message |
|---|---|
| Passenger name | Passenger Name |
| PNR Number | Cabin Number |
| Airline | Cruise line |
| Flight Number | Cruise number |
| Departing Station | Embarkation Port |
| Arrival Station | Disembarkation Port |
| Bag Tag Number | Luggage Lable Number |

On receipt of the bag tags, the passenger prints the tags, if they have been sent in electronic format at step 1604. Alternatively the tags may be sent to the passenger by mail, for example along with other information about their reservation. The tags preferably include a 2D bar code which includes the unique bag number identifier and passenger information. When the passenger arrives at the port with their bags, the bags are each scanned at step 1606 with a mobile communications device or a dedicated scanner in the manner described above and the status of each bag is updated via a BSM as described above to indicate that the bag(s) have been checked in. As a BSM as already been issued for each bag, the bag data retrieved by the scan is validated against the original BSM to ensure that it tallies. At this point the system may create a new BSM with the updated status or update the existing BSM. At this point the cruise operator knows the identity of the bags that are on board the vessel unlike existing systems.

As the passenger, who has now handed over their bags, boards the ship, they may scan a touch point with their mobile device having a passenger app loaded. Passenger details are read from the device by the system which can push data to the app. At a point when the passenger's bags have been delivered to their cabin, the system pushes a message, at 1608, to the passenger informing them that their bags are at their cabin and that the passenger may now go to their cabin. Bags are delivered by a porter who scans the bags and a location identifier arranged on or near the cabin door at 1610 to indicate that the bags have been delivered to the cabin. The status of the bag is again updated via a BSM which is sent back to the central system. This is one example of how the location of the bag can be tracked throughout the voyage. It is possible to include as many touchpoints as is considered necessary. In the airline industry, the touchpoints at which an airline must track baggage are regulated by IATA Resolution 753. However this does not apply to the maritime environment which gives cruise operators latitude to introduce as many touch points as they consider beneficial.

As an alternative to this step the system may wait until all bags have been delivered to a given area, for example a deck, and then push a message to all passengers with cabins on that deck to advise them that their bags have been delivered and that the can access their cabins. This has the benefit that passengers are kept away from the deck when baggage is being delivered so enable the baggage delivery staff to operate unimpeded.

It is presently preferred that messages from the system to passengers are sent via a dedicated app, which may be downloaded by the passenger from any suitable venues, such as Apple® App Store, Google Play® or other similar venues. Alternatively the system could communicate with passengers by pushing SMS, instant messaging or email or any other messaging protocol. In either case, a translator is required between the Bag messages and the messaging application to translate the message into text that can be understood by the passenger. However, such translators are known to those skilled in the art.

As a cruise liner approaches a destination port, typically the night before, passengers leave their bags outside their cabins for collection. They are collected, taken to the hold and loaded into cages in deck order. At step 1612 the bag collection provides a touchpoint so that the system knows that the bags are again in the possession of the cruise operator. The bags are scanned again when they are loaded into the cage and a location identifier on the cage is also scanned so that a message can be sent that identifies a given bag with a particular cage. This message may be sent both to the system and pushed to the passenger.

When the ship arrives in port, bags are typically unloaded by forklift truck onto the quayside and taken into the customs hall where they are emptied forming very large lines of bags arranged in deck order. In an embodiment of the invention the bag has already been associated with a cage location and that information has been pushed to the passenger's app on their mobile device so that the passenger knows where to find their bags. As the bags are unloaded from the cages, they are scanned again at 1616 together with the cage identifier, which may be a barcode mounted on a card fixed to the cage. If the scanned cage number does not agrees with the cage number that is associated with the bag, the scanner returns an error message to the user who can then determine the correct cage number and return then bag to the correct location for bags unloaded from that cage. This greatly reduces the time that can be wasted searching for mishandled bags which is a very significant problem on larger cruise liners that can be handling in excess of 10,000 bags on a single voyage.

As the passenger leaves the baggage hall, having collected their bags, the bags are scanned again indicating that the cruise operator no longer has responsibility for the bags. The scanner may again update the status of the bag to ‘retrieved’. This step can greatly assist the cruise operator in the prompt and efficient unloading of bags. On larger ships, where quay space is limited, it is necessary to unload bags one deck at a time and not to place bags from a new deck on the quay until the previous deck has been fully or almost fully collected. Similarly, passengers are disembarked one deck at a time so that the only passengers on the quay should be those from the deck the bags of which are on the quay. This is necessarily a time consuming process. By scanning bags as passengers exit the customs hall, the system knows how many bags remain and can calculate whether it can allow the next deck of passengers to disembark. This improves the speed and smoothness of disembarkation and baggage collection and may lead to a great improvement in passenger experience. Moreover, as the cruise operator now knows exactly how many bags they are carrying, they can advise the port in advance of the baggage load so that the port can assess the staffing required to handle the disembarkation.

As mentioned above, the architecture for the cruise ship application is very similar to that of the airline application of FIG. 1. The Airline DCS is replaced by the Cruise Reservation System which, itself, is well known. The data store 108 is preferably located in the Cloud and no dedicated local storage need be provided on the ship. As cruise ships may not always be in contact with the data base, for example when they are in the middle of an ocean, it is important that the scanners have sufficient storage to hold data offline. Although a cruise liner will have the ability to communicate with the shore, it may be limited and slow. Moreover, it may not be possible to prioritise bag related messages over other messages sent by the ship making communications with the data store unreliable and, therefore undesirable, for large parts of a cruise. When a ship approaches a port, there will be a transition point, for example on docking, when control passes back to the main ground based system. At that point, the scanners can connect with the data store and go back on line again. It will be appreciated from the description above that the majority of the steps in FIG. 16 are performed when the ship is docked.

While the ship is at sea, messages may be passed internally within the ship using the ship's on-board Wi-Fi although this is typically of low bandwidth and reliable.

Any suitable scanner may be used to scan bar codes on bag tags and location identifiers. For example a scanner app on a mobile device may be used. Many such apps exist and are known to those skilled in the art. Alternatively dedicated Bluetooth® scanners may be used as a cheaper option. Such scanners are also very well known to those skilled in the art. Glove scanners may be used, or other wearable scanners in which the scanner is mounted on a glove or other article of clothing, facilitating scanning. Where the scanner is being used to scan large numbers of articles it may be preferred to use a more rugged protected device such as the DataMan® 8050 series handheld barcode reader provided by Cognex, Inc of Natick Mass., USA. Such a scanner is able to scan barcodes for a distance of up to 10 m and store data and is therefore highly suited to this environment. Many other similar scanners are available and may be used. Alternatively, cameras, such as those in mobile devices such as phones and tablets may be used to capture and process bar codes. However, scanners are presently considered to be more accurate and reliable. Scanners such as the Cognex Dataman series have rechargeable batteries with a time between charging in the order of 10 hours making them well suited to the present environment.

As mentioned above, the architecture of the system is very similar to that of FIG. 1. On board ship, the system may be administered from a central administration room. FIGS. 17 and 18 are screen shots showing the information that is available to a system user either from a land based control room or a shipboard administration room. In each case the screen shows the event history of a particular bag tag. FIG. 17 shows the embarkation process whereas FIG. 18 shows the disembarkation. In each case the bag tag is identified as 0BA474187 and the cruise is scheduled to depart on 23 Oct. 2018. The passenger is identified as Mr David Munro and his passenger number is K3RVTJ. In these examples the display is based on an airport display and the references to flight numbers may be ignored. In FIG. 17 the passenger has arrived at the port of Glasgow (GLA) by air from London City Airport (LCY) on flight BA8721. In FIG. 18 the passenger arrives at the port of Glasgow by ship and transfers to London City by air. The FIG. 17 display illustrates that on 23 Oct. 2016 at 05:40 a bag was checked in. This means that the bag was presented by the passenger, the bag tag was scanned and a BIM message created for the bag which was sent to the system. The entry for 05:40 shows the existence of the BIM and the passenger status (checked-in) and the passenger number. The display also shows that the luggage was loaded to the ship at 08:15 and delivered to the passenger's cabin at 08:16. For each of these messages, for information can be obtained by the user by clicking on the information tab in the BIM column. At each stage the bag has been scanned and, optionally, a message pushed to the passenger to inform them of the progress of their baggage.

At the top of the display is an indication that the bag has been checked in and delivered to the passenger.

Similarly, the disembarkation screen of FIG. 18 shows that the bag has been delivered to the passenger and that the steps at which the bag tag has been scanned and a bag movement recorded are: collection of the bag from the cabin; offloading of the bag from the ship; delivery of the bag to customs; and delivery of the bag to the passenger following customs. Again, the event description shown in the figure is a result of scanning the bag tag and updating the bag message. Also a message may be sent to the passenger via the mobile app on their mobile device to advise of progress of their baggage.

Embodiments of the invention have many advantages over the prior art. For example, they provide for greatly increased security over that which is available at present on cruise liners. Unlike existing systems, embodiments of the invention enable the cruise operator to know exactly how many bags are on board the ship and each bag has a unique identifier. At present, bags on cruise ships have a label which identifies the passenger name, cabin number and cruise but there is no central recordal of that information. Embodiments of the present invention provide a unique identifier which links a bag to and individual passenger in a manner that can be read and accessed centrally by an administrator.

Embodiments of the invention also increase security with respect to potential smuggling and terrorist offences. The existing system of issuing labels to passengers is open to abuse as labels may easily be copied. Embodiments of the present invention enable a manifest to be kept that links bags to passengers. As this information is captured as the passengers embarks, bags can be validated before departure and rogue bags eliminated.

Embodiments of the invention also have the advantage of enabling the bag handling process to be streamlined throughout the entire cruise. However, it is particularly advantageous at when passengers are collecting bags at the arrival port. As mentioned above, the linking of bags with cages enables mishandled bags to be identified and correctly stored potentially saving a lot of time at the quayside. This, and other efficiencies provided by the system enable passengers to be processed more rapidly at the arrival port decreasing disembarkation times which is advantageous to the passengers, the port operator and the cruise operator. Moreover, as the port operator can now have advance knowledge of the number of bags a ship is carrying it can make an appropriate assessment of what resources are required to handle the ship so increasing the efficiency with which the arriving ship is dealt and avoiding unnecessary or insufficient staffing.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit and scope of the disclosure.

1. A method of tracking baggage on a cruise ship, comprising the steps of:
for an item of baggage, generating a unique baggage identifier and associating the unique baggage identifier with a unique passenger identifier to form a unique identifier, the passenger identifier being retrieved from a reservation system;
generating and storing a baggage message including the associated unique identifier;
generating a baggage tag including the unique identifier and affixing the baggage tag to the bag;
on delivery of the baggage to a passenger's cabin on the cruise ship:
scanning a location identifier in the region of the cabin with a scanning device and notifying the passenger via a mobile application stored on the passenger's mobile device that the baggage has been delivered to their cabin, and updating the baggage message with the status of the bag;
prior to arrival at a destination port:
collecting the baggage from a passenger's cabin;
scanning the baggage tag;
updating the status of the baggage message; and
on unloading of baggage at a port:
sending a message to the mobile device of the passenger associated with the baggage via the mobile application notifying them where to collect the baggage.

2. A method according to claim 1, comprising, prior to embarkation of the passenger onto the cruise ship, scanning the baggage tag with a scanning device to read the unique identifier, validating the unique identifier against the stored baggage message to enable check-in of the baggage, and updating the baggage message.

3. A method according to claim 1, comprising, on collecting the baggage from a passenger's cabin, sending a message to a passenger's mobile device via the mobile application informing the passenger that their baggage has been collected for debarkation.

4. A method according to claim 1, comprising, on collection of the baggage from a passenger's cabin, loading the baggage into a baggage container, scanning a baggage container identifier and associating the baggage container identifier with the baggage and sending an updated baggage message including the association.

5. A method according to claim 4, comprising, on unloading of the baggage containers at a port:
for a given item of baggage, scanning the baggage container identifier in which the item of luggage is held and the baggage tag of the item of baggage with a scanning device, retrieving the associated baggage container identifier for the item of baggage and determining whether the retrieved identity matches the scanned baggage container identifier.

6. A method according to claim 1, comprising, on departure of the passenger from the port, scanning the item of baggage and updating the status of the baggage in the baggage message to indicate that the baggage has left the port.

7. A method according to claim 1, wherein the baggage identifier fixed to the baggage is a bag tag, an RFID or a BLE beacon.

8. A method according to claim 1, where the or each location identifier is a bar code or a GPS module.

9. (canceled)

10. A method according to claim 1, wherein the passenger identifier comprises passenger related data retrieved from a passenger name record stored in the reservation system.

11. A method according to claim 1, wherein the item of baggage is stored in the bag message as being unknown.

12. A method according to claim 1, wherein the steps of scanning are performed by one or more hand held scanning devices.

13. (canceled)

14. A method according to claim 1, wherein the step of generating a baggage tag comprises generating the baggage tag electronically and sending the baggage tag electronically to the passenger.

15. A method according to claim 1, wherein the step of updating the baggage message comprises changing the status of the item of baggage in the baggage message.

16. A method according to claim 1, wherein the step of updating the baggage message comprises generating and saving a new baggage message, the new baggage message having a different baggage status from the previous baggage message.

17. A method according to claim 1, comprising, on boarding the ship, the passenger scanning a touchpoint with a scanning app loaded on a mobile communications device, and communicating a signal to update the status of the baggage message permitting delivery of the passenger's baggage to their cabin.

18. A method according to claim 1, wherein the scanning of the baggage tag prior to arrival at a port comprises sending a message to the passenger via the mobile application indicating that the item of baggage is in the possession of the cruise operator.

19. A method according to claim 4, wherein after associating the baggage container identifier with the baggage and sending an updated baggage message including the association, sending a message to the passenger's mobile communications device via the mobile application indicating the identity of the baggage container.

20. (canceled)

21. A system for tracking baggage on a cruise ship, comprising:
a processor adapted to generate and associate for an item of baggage a unique baggage identifier with a unique passenger identifier to form a unique identifier, the passenger identifier being retrieved by the processor from a reservation system;
the processor further adapted to generate and store a baggage message including the unique identifier in a data store; and to generate a baggage tag including the unique identifier for affixing to the bag;
a scanning device for scanning a location identifier arranged in the region of the passenger's cabin, the scanning device including software for notifying the passenger via a mobile application stored on the passenger's mobile device that the baggage has been delivered to their cabin, and for updating the baggage message stored in the data store with the status of the bag;
a scanning device for scanning the baggage tag prior to arrival in a port having software for updating the status of the baggage message; and
a communications device for sending to a mobile device of the passenger, on unloading of baggage at a port, a message notifying the passenger where to collect the baggage.

22. A system according to claim 21, comprising a scanning device for scanning the baggage tag prior to embarkation of the passenger onto the cruise ship to read the unique identifier, the scanning device including software for communicating with the data store to validate the unique identifier against the stored baggage message, thereby to enable check-in of the baggage, and for updating the baggage message.

23-26. (canceled)

27. A method of tracking baggage loaded onto a cruise ship, comprising the steps of: for an item of baggage, generating and associating a unique baggage identifier with a unique passenger identifier to form a unique identifier, the passenger identifier being retrieved from a reservation system;
generating and storing a baggage message including the unique identifier;
generating a baggage tag including the unique identifier and affixing the baggage tag to the bag;
prior to embarkation of the passenger onto the cruise ship:
scanning the baggage tag with a scanning device to read the unique identifier, validating the unique identifier against the stored baggage message to enable check-in of the baggage and updating the baggage message; and
following boarding of the passenger and on delivery of the baggage to a passenger's cabin: scanning a location identifier in the region of the cabin with a scanning device and notifying the passenger via a mobile application stored on the passenger's mobile device that the baggage has been delivered to their cabin, and updating the baggage message with the status of the bag.

28-29. (canceled)
